(19) United States
(12) Patent Application Publication
(10) Pub. No.: US 2023/0273607 A1
(43) Pub. Date: Aug. 31, 2023

(54) INSPECTION RATE ADAPTATION

(71) Applicants: Marcel Rothering, Nürnberg (DE); Tobias Seutter, Nürnberg (DE); Volker Lorrmann, Güntersleben (DE)

(72) Inventors: Marcel Rothering, Nürnberg (DE); Tobias Seutter, Nürnberg (DE); Volker Lorrmann, Güntersleben (DE)

(21) Appl. No.: 18/009,466

(22) PCT Filed: Mar. 22, 2021
(86) PCT No.: PCT/EP2021/057220

§ 371 Date: Dec. 9, 2022

(30) Foreign Application Priority Data
Jun. 9, 2020 (EP) 20179003.7

(51) Int. Cl. G05B 19/418

(52) U.S. Cl. CPC G05B 19/41875; G05B 2219/32201; G05B 2219/36386

(57) ABSTRACT

A method of operating a production for producing a plurality of products is provided. The method includes inspecting the products according to a first inspection rate. The inspection rate determines the number of products that are inspected during a period of time and/or from a given set of products. An inspection of one of the products includes testing (e.g., in a first number of testing steps) at at least one inspection station. The method includes obtaining test data based on the inspection of at least one of the products, and setting a threshold for a number of products not fulfilling the testing (e.g., during a specified period of time). The method also includes determining a second inspection rate based on the threshold set and the test data obtained, and inspecting the products according to the second inspection rate. The second inspection rate may be lower than the first inspection rate.

This application is the National Stage of International Application No. PCT/EP2021/057220, filed Mar. 22, 2021, which claims the benefit of European Patent Application No. EP 20179003.7, filed Jun. 9, 2020. The entire contents of these documents are hereby incorporated herein by reference.

### TECHNICAL FIELD

The present embodiments are related to monitoring and/or testing arrangements for controlling production.

### BACKGROUND

Collecting production data or the associated data collection process is a very integral part of the production management, production planning, and inventory management process. It is important that the collecting or the data collection process is done correctly in order to obtain a true picture of the process. In addition, the collecting or the data collection process should be done in an efficient and faithful manner in order for the collection or the data collection process to be analyzed by production engineers and management to understand what is happening in the production plant with respect to process quality, efficiency, and overall equipment effectiveness (OEE) of machinery. Data collection from a production process may be done either through manual processes and paperwork or through a production/process management software system. The collection method chosen will depend on the size and complexity of the production process being managed, as some software packages may be costly to purchase and implement with requirements for different sensors, PLCs, relays, computers, and control loop systems.

From U.S. Pat. US628146B1, a device and method for predictively diagnosing the prevailing quality of the technical work result of a technical installation (e.g., the prevailing quality of the welding spots of a spot-welding robot) have become known.

In practice, it may be extremely difficult to determine the prevailing quality of the product of a technical installation (e.g., a production system). In contrast to determining physical quantities using measuring techniques, in many cases, there are no common direct measuring methods available for determining the quality parameters of production results. In some cases, there is success in assembling a highly specialized, complex measuring arrangement that, for example, is based on radiological, electromagnetic, or optical principles or a combination thereof. Many times, however, it is still to be provided that the prevailing quality parameters are to be subjectively determined by experienced operating personnel (e.g., within the framework of a “quality control”). This produces a multitude of disadvantages. First, the determination of quality parameters by experienced operating personnel is neither representative nor reproducible. Rather, assessments of this kind vary even in the short term, depending on the operating personnel employed and respective daily conditions. Further, operating personnel may generally only carry out evaluations of quality parameters on selected production results of the respective installation by taking random samples. A temporary absence or a change of “experienced operating personnel”, for example, make it impossible to prevent unreproducible assessment variations in the long term, as well.

Second, exceptional outlay is to be provided to be able to use the quality parameters, gained from the assessments by the operating personnel, along the lines of open-loop or closed-loop control engineering in the form of control variables or adjusted setpoint values for influencing the operational performance of the respective technical installation. In the case of high-speed, possibly fully automatic, production plants, for example, it is almost impossible in practice for the characteristic quality values, gained from random samples, to be made usable sufficiently quickly to influence the operational equipment of the technical installation.

From U.S. Pat. Application Publication US 2018/0307203 A1, a machining defect factor estimation device that includes a machine learning device that learns an occurrence factor of a machined-surface defect based on an inspection result on a machined surface of a workpiece has become known. The machine learning device observes the inspection result on the machined surface of the workpiece from an inspection device as a state variable, acquires label data indicating the occurrence factor of the machined-surface defect, and learns the state variable and the label data in a manner such that the state variable and the label data are correlated to each other.

However, an artificial neural network is a black box, and its decision mechanisms is not comprehendible to a human. In addition, training of the artificial neural network requires ample amount of data be available.

### SUMMARY AND DESCRIPTION

The scope of the present invention is defined solely by the appended claims and is not affected to any degree by the statements within this summary.

Different aspects are disclosed herein that reduce the technical effort when it comes to inspecting products and that allow easy scaling of the inspection effort and are easily transferable between production systems producing different products.

According to a first aspect, a method of operating a production for producing a plurality of products is provided. The method includes inspecting the products according to a first inspection rate. The first inspection rate determinates the number of products that are inspected during a period of time and/or from a given set of products. The inspection of one of the products includes testing (e.g., in a first number of testing steps) at at least one inspection station. The method further includes obtaining test data based on the inspection of at least one of the products and setting a threshold for a number of products not fulfilling the testing (e.g., during a specified period of time). The method further inlcudes determining a second inspection rate based on the threshold set and the test data obtained, and inspecting the products according to a second inspection rate. The second inspection rate is, for example, lower than the first inspection rate.

Products are usually inspected on site at the place of production. Further, products usually are inspected at one or more stages of production (e.g., between production steps between two successive production steps, or at the end of the line (EoL)). Being a key element of quality control, product inspections allow to verify product quality at different stages of the production process and prior to its dispatch. Inspecting a product before it leaves the production is an effective way of preventing quality problems and supply chain disruptions further down the line.

An inspection may include test criteria such as product function, performance, overall appearance, and dimensions. Whether a product meets the test criteria may be determined in one or more testing steps. As a result of the testing steps or of the inspection of a product, in general, test data may be obtained. Accordingly, a threshold for a number of products may be set. The threshold may correspond to the number of products fulfilling or not fulfilling (e.g., passing or failing) an inspection. In any case, the threshold set allows identifying a (maximum) number of products not fulfilling testing. Now, the period of time for which the inspection according to the first inspection rate is carried out may correspond to one or more production cycles or to the period of time it takes to produce a predetermined number of products.

Inspection according to the second inspection rate may be carried out for a subsequent period of time subsequent to the period of time the inspection has been carried out according to the first inspection rate. This subsequent period of time may be as long as the first period of time. Alternatively, the subsequent period of time may (e.g., depending on the specific circumstances of production) be shorter or longer than the preceding period of time during which inspection according to the first inspection rate has been carried out.

The second inspection rate may be determined based on the threshold set and/or the test data obtained. For example, the test data may serve for determining a probability distribution of the test variables. The one or more test variables may thus represent the one or more test criteria. Based (e.g., solely) on the probability distribution, the second inspection rate may be determined. For example, the first inspection rate may be lowered (e.g., by 10 %) in order to yield a second inspection rate in case the probability distribution predicts less products not fulfilling the one or more test criteria. In general, the second inspection rate may be adapted based on (e.g., a property of) the probability distribution or a change of (e.g., a property of) the probability distribution. Additionally or alternatively, the inspection rate may be adapted (e.g., solely) based on the threshold set. For example, if the threshold is lowered (e.g., fewer products not fulfilling the inspection), the number of inspections per time or set of products (e.g., the inspection rate) may be increased resulting in a second inspection rate.

According to a second aspect, an apparatus is provided. The apparatus is operative to perform the acts of the first aspect. In one embodiment, the apparatus includes a processor and a memory that perform the acts of the method according to the first aspect.

According to a third aspect, a production system including one or more apparatuses according to the second aspect is provided.

According to a fourth aspect, a computer program product and/or a non-transitory medium including program code that when executed performs the method acts according to the first aspect is provided.

### BRIEF DESCRIPTION OF THE DRAWINGS

FIG. 1 is a schematic illustration of a production including closed-loop analytics;

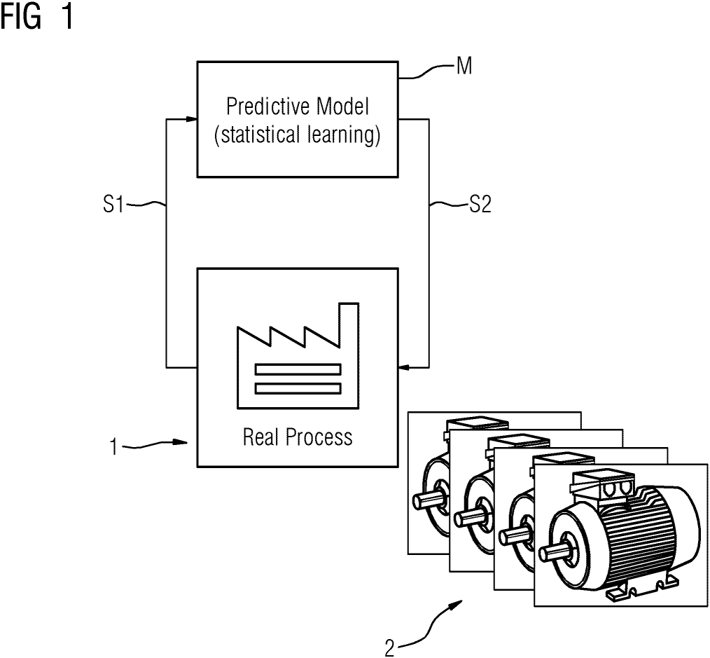

FIG. 2 shows a probability distribution of a test variable;

FIG. 3 shows risk parameters k, α and possible savings;

FIG. 4illustrates test effort during different time intervals; and

FIG. 5 is an exemplary production system.

### DETAILED DESCRIPTION

In the manufacturing industry (e.g., electronics or motor production), production 1 includes a variety of individual production acts. During the production 1, quality-assurance measures provide that the product 2 meets the requirements and may be used error-free. The quality with which products 2 as well as individual components and component groups are tested has already been exhausted to a “maximum”. Production may today already achieve up to 99% FPY (first pass yield) rates. This provides that 99% of the products 2 are error-free. Hence, by product, a component or part of the final product may be understood. These quality assurance measures are costly and time-consuming, as the quality assurance measures require, among other things, usage of personnel as well as test and testing procedures, which may also need to be developed or further developed. A saving of these non-value-enhancing work steps opens up enormous financial potential. For this reason, solutions have already been developed that include such quality assurance measures in terms of complexity and time required and, in the end, also lead to a significant increase in efficiency in the production 1. An extremely promising approach is the “Closed Loop Analytics” (CLA) offered by SIEMENS®. Therein, an analysis based on machine learning algorithms is provided in order to make reliable statements about the quality of the component, without requiring a physical testing.

The main starting point is a data set (e.g., process parameters during production such as temperature, pressure, etc., as well as target values assigned to input data, such as the delay of a part in one or more production stations) that allows a statement about the quality of the component. The data set may be obtained from the production 1 in act S1. On the basis of this data set, it is possible to create predictive models M that allow to make predictions about the product quality to be made purely based on the input data, whereby, for example, algorithms and methods from the field of machine learning are employed. The result of the predictive model may be transmitted to the production 1 in act S2. However, it is precisely this data set that often presents the following challenges:

Insufficient amount of data: Often, no or insufficient process data that allows a meaningful predictive model M to be generated is available. This may be, for example, because not enough process data is recorded. Without sufficient data, however, it is almost impossible to achieve a reliable predictive model M.

Quality of data: In order to create a meaningful predictive model M, not only is a sufficient amount of data to be provided, but also the data is to be of high quality. A “noise” in the data set (e.g., the correlation between the input data (e.g., temperature, pressure) and the output data (e.g., distortion of a metal sheet a particular manufacturing station) is not always unambiguous, and may also give rise to a qualitatively poor model. In addition, for example, for manufacturing processes that already offer a very high-quality standard, problems with the predictive model may arise. A predictive model is to also detect “outliers” or production deviations that lead to quality problems. These, however, are usually an exception in the data set and may be insufficiently captured by the predictive model. Especially when reusable prediction models M are developed for customers with the same or similar production processes, this may be become a problem, since different users may use different parameter settings.

Non-measurable sizes: Not all process parameters that have a significant impact on component quality are measurable. This may, for example, be the mechanical voltage in a deep drawing component during the pressing process in the tool or the temperature in the center of a casted component. In both cases, a measurement may be almost impossible or at least very difficult, but the quality of a component may be predicted very well if the parameters were known.

Duration of the training phase: Especially if hardly any data is available for a production 1 or the production 1 is being rebuilt, it may take a long time (e.g., up to several months) to gather a data set that allows the creation of a reliable predictive model M. In addition, an already productive system may be adapted, which requires gathering a new data set.

In order to overcome these drawbacks, one or more following approaches may be used: Data-based quality control, direct measurement (e.g., End-of-Line testing as the last step in production), process simulation.

Data-based quality control: As described in the above, it is possible to carry out a data-based quality check based on process and manufacturing data and a predictive model M. The predictive model M may include different methods that are usually used for machine learning (e.g., decision trees, time series models, neural networks).

Process simulation: Today, there are many different ways to simulate manufacturing processes and material influences digitally. Such process simulation is available in many production areas, such as forming, and are intensively used in process development. There are continuous process simulations (e.g., physical/chemical processes) and discrete process simulations (e.g., material flow simulation), whereby for the purpose of the quality assessment of components and assemblies, only continuous simulations may be used. These simulation technologies are already so advanced that certain processes are simulated with very high accuracy (e.g., partly below 5% deviation). This makes it possible to develop and optimize processes on the computer and examine all relevant aspects that may have an impact. An example thereof is described in international patent application PCT/EP2019/079624 and respectively European patent publication EP3667445 with title “METHOD AND DEVICE AND METHOD FOR PRODUCING A PRODUCT AND COMPUTER PROGRAM PRODUCT”.

Direct quality control: Special machines and equipment, which allow a quality check, may be used at at least one inspection station. For example, soldering points may be controlled by X-ray, or after a deep drawing process, a distortion measurement takes place via image recordings or laser measurement. Such inspection stations exist in many different forms with the frequent disadvantage that such inspection stations are very expensive and often slow down production or form a bottleneck in the production.

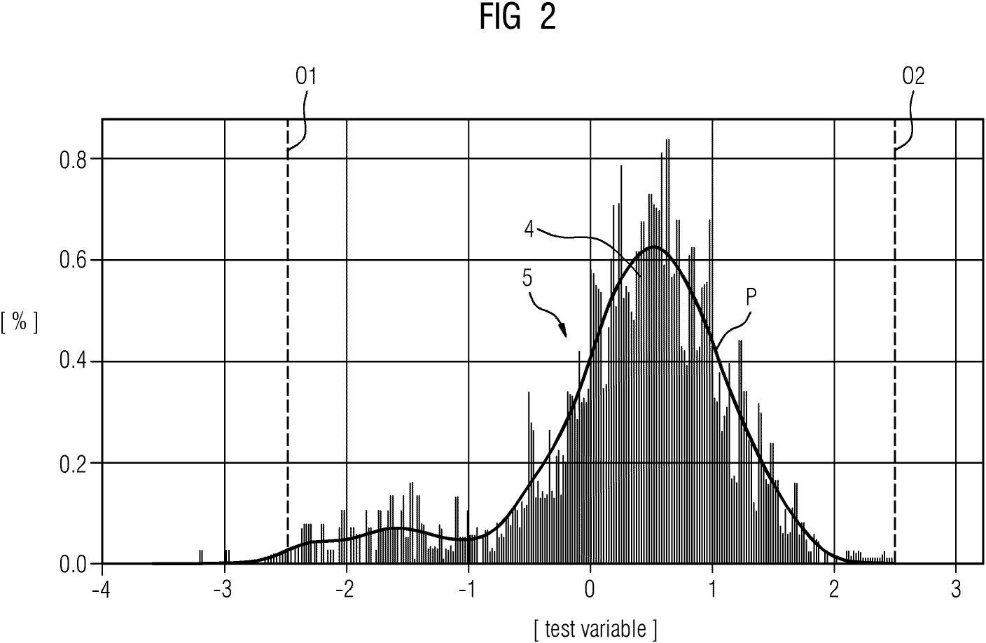

A production system (e.g., a production line) and a method for operating the same that allows increasing the efficiency of the quality control of products by using a predictive model P based on test data is provided. The method includes one or more of the following acts: 1) a probability P (e.g., probability distribution) for a defective product (e.g., for an upcoming time interval) is determined based on the probability P (e.g., probability distribution) of a test variable 5 (e.g., in an elapsed time interval, cf. FIG. 2). Test data is obtained as a result of testing T. The values of one or more test variables 5 are obtained (e.g., in act K1) as a result of the one or more testing steps performed during testing T (e.g., testing according to a first inspection rate). Whether a product 2 is defective is determined based on whether the part or product fulfills one or more testing steps during testing T. For example, a threshold or one or more tolerances for the value(s) of one or more test variables 5 may be set, and based on the threshold or the one or more tolerances, it is determined whether the product 2 fulfilled the testing T or not. Different methods may be used for determining the probability (e.g., distributions) of a defective product. For example, in case the test variable is known to be continuous (e.g., the measurement of a continuous test variable such as temperature is performed), a kernel density estimation (KDE) may be used to fit the data and to determine the probability distribution. This probability distribution function may then be used to determine (e.g., calculate) an area outside of the tolerances O1, O2 (e.g., one or more thresholds set). The area outside to the tolerances O1, O2 may correspond to probability of a part or product not fulfilling the testing T. In order to achieve the best possible estimate for the probability distribution P, this procedure may be performed several times based on different bootstrap samples. The results of the probability distributions P may then be aggregated. In case the test variable is discrete, a Bayesian approach, as described in more detail below, may be used.

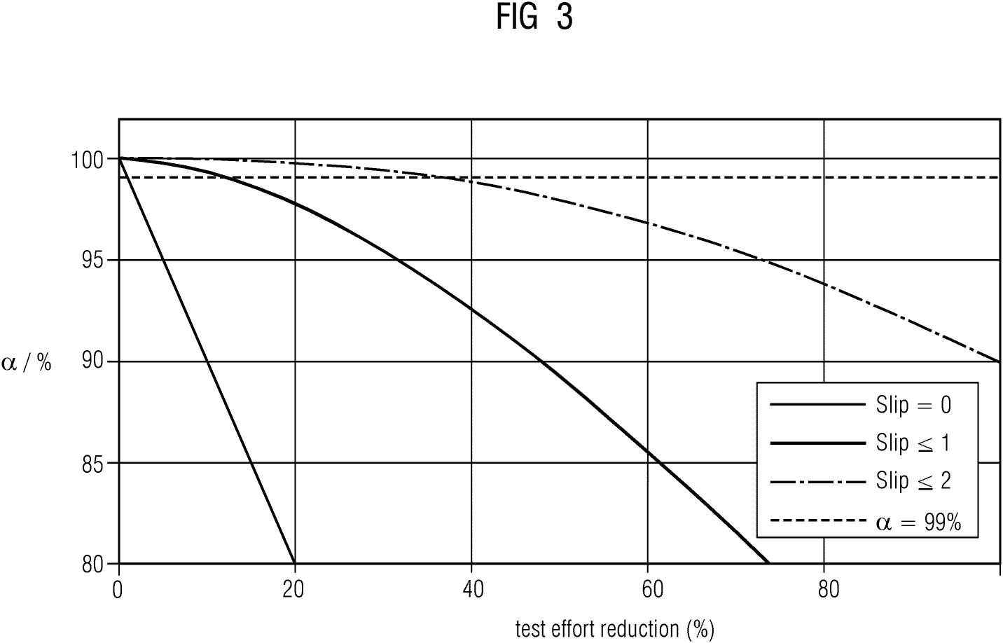

2) Based on the probability distribution P, the savings potential of tests (e.g., and cost of the test; a possible reduction of test) for the upcoming time interval using the binomial distribution may be determined. This calculation may be made taking into account two (e.g., customer-individual) risk parameters: i) a maximum accepted slip k (e.g., the number of defective products that are delivered untested); ii) a confidence level α (e.g., 99%) that describes the probability that no more than k slips occur. Different combinations create different savings potentials. High values for α and low values for k result in low savings potential but reduce the probability of slips. This trade-off (e.g., slips k vs. test reduction) may be set individually per test variable. In FIG. 3, this trade-off is visualized. The test (e.g., effort) reduction in percentage results from the normalization of the absolute number of products to the time interval used for the prediction. If the customer already has order data for the upcoming time interval, the data from that upcoming time interval may be used.

3)The calculated savings potential for the upcoming time interval may be returned to production and/or test systems. In other words, the inspection of the products may be continued with an adjusted inspection rate.

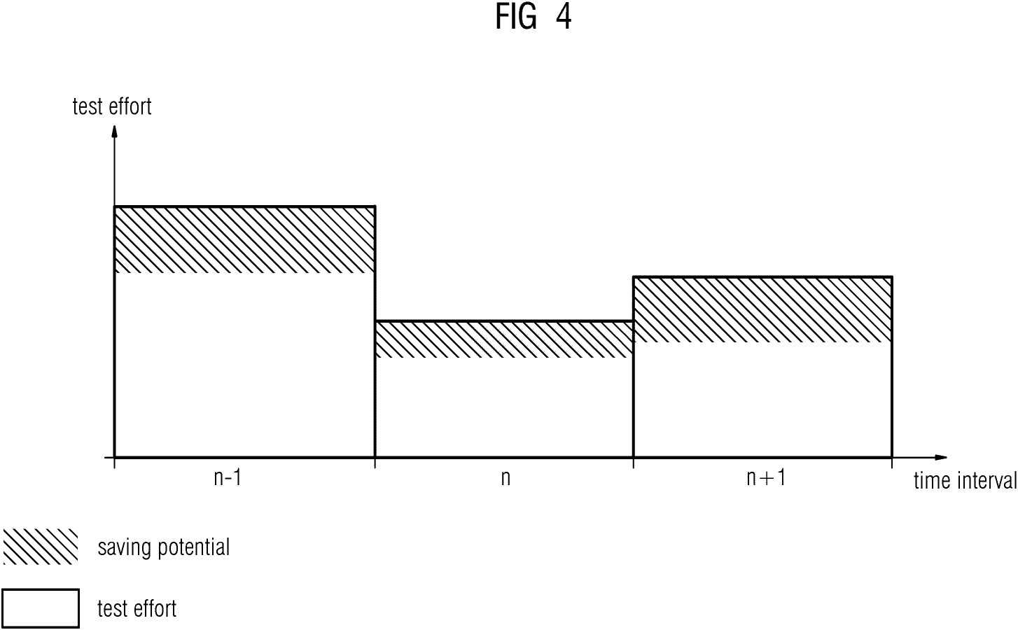

4) In the upcoming time interval, various metrics, such as the probability of failing the testing, the number of outliers, and error, may be monitored, as shown in FIG. 4, and the test effort may be dynamically adjusted (e.g., dependent on the time interval n-1, n, n+1) to provide the previously defined risks are met.

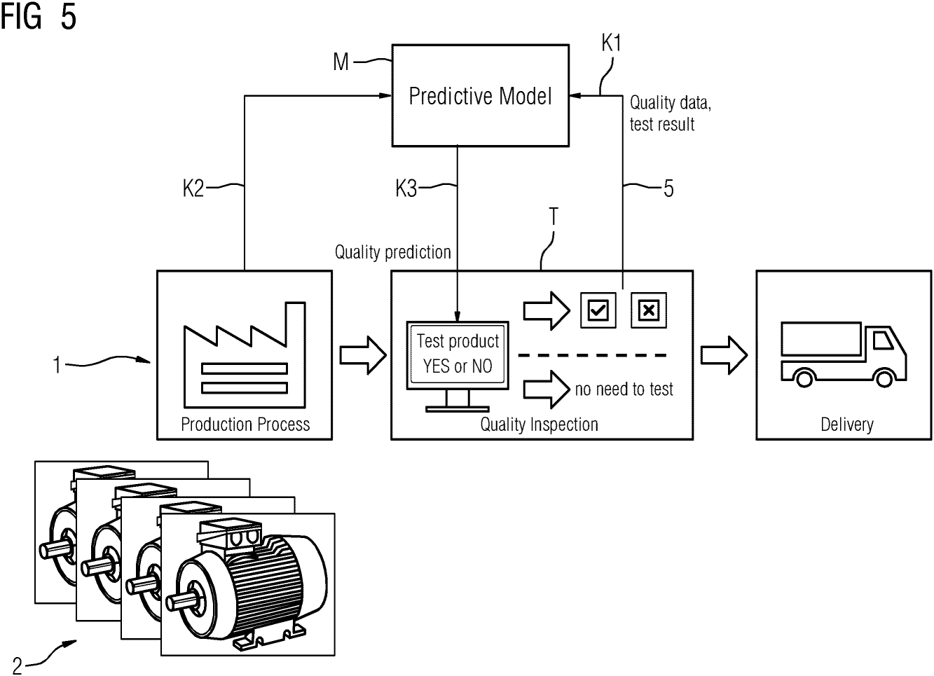

Turning to FIG. 5, the production system may include a real production process, which is to be monitored regarding the quality of products produced. For this purpose, there, data acquisition (e.g., by sensors) of quality-relevant data is foreseen in the production (e.g., forces, pressures, temperatures, etc. may be measured). In addition, test data, such as upper and lower limits and/or measured values of one or more test variables, that are recorded during an inspection at at least one testing station may be gathered. In order to prevent every component from being examined manually, a predictive model may monitor the production (e.g., process) and may, based on the quality-relevant data and/or the test data, in additionally historical quality-relevant and/or test data for the component, predict the quality of the component. For this purpose, the quality-relevant process data as well as the test data may be transferred (e.g., continuously) to the predictive model M, in acts K1 and/or K2, respectively, which may provide a corresponding quality forecast, in act K3.

Inspection of the products 2 may take place at the end of the line. The relevant properties and features of the device under test may be selected for the end-of-line test to determine overall quality, perform fast measurements and produce meaningful data, and arrive at a correct Pass/Fail decision. Testing in production 1 (e.g., between two production steps in a multi-step production) may be performed alternatively or additionally. For example, in case of motor production, the test variables may be any one or more of the following: a current ripple factor, periodically fluctuating strain (e.g., rotational ripple), adjustment angle (e.g., of rotation with respect to the shaft), Line-to-line output voltages and/or corresponding electrical resistances, electromotive force (EMF) and optionally higher harmonics of the electromotive force, braking voltage (e.g., as applied to the motor windings), and temperature measurements (e.g., for validating the measurements of the thermometers integrated into the motor). Additional test variables may be used in the case of testing motors of a motor production. Further, for productions, suitable test variables may be used when testing different products, such as printed circuit boards.

In order for a predictive model M to be created and also to have a sufficient forecast quality, a sufficient data set, both qualitatively and quantitatively, is to be provided. Previously, production 1 had to run for a long time (e.g., in some cases, several months) or a sufficient data set was already generated in the past, which is more of an exception. With the approach disclosed herein, other data sources that complement or replace the real process data are provided.

In this section, the one or more acts, as described in the above, will be described in more detail. First, calculation of the probability distribution of error per test variable is described. Then, predicting possible test effort reduction and monitoring measures will be discussed.

### 1 Calculation of the Probability of Error

The probability (e.g., distribution) of an error (e.g., a part or product not passing or fulfilling the testing (requirements)) describes how likely it is that the measured test variables of a testing step are outside a threshold set (e.g., one or more tolerances). Hence, the probability distribution P may be part of the predictive model M. For this purpose, the historical data of the one or more testing steps in the previous time interval may be used. The size of the time intervals may be individually adapted (e.g., to certain production cycles). A time interval may correspond to a fraction of a second up to one or more months. The measured test variables from the previous time interval represent a univariate distribution, which may be approximated (e.g., using Kernel Density Estimation (KDE)). In order to provide the best possible estimator for the probability of error, a number of exponentially and time-wise weighted bootstrap samples are created and aggregated into an error probability (e.g., distribution), which may also include a confidence interval. For the purpose of boot strapping, the exponential weighting allows putting more emphasis on more recent measurements (e.g., of the one or more test variables) at the end of the previous time interval, and less emphasis on the measurements at the beginning of the previous time interval. The aggregated KDEs may then be used together with the upper and lower tolerance limits to calculate the probability of error.

### 2. Calculation of Test Reduction

With the probability of error calculated, as described in the above, for the previous time interval, a number of reduced tests may be determined. A binomial distribution may be used for this determination. The parameters k (e.g., number of maximum slips in the upcoming time interval) and α (e.g., probability of no more than k slips in the next time interval) may be set, for example, individually by a user. After these parameters have been fixed, the binomial distribution may be solved for n (e.g., number of reduced tests). Subsequently, in order to indicate a test reduction in percent, the number n is set in relation to the number of tests in the previous time interval or, if known, set in relation to the subsequent time interval. In order to be able to repeat act 1 reliably again in the time interval after the subsequent time interval, a sufficient number of tests is to be performed during the subsequent time interval (e.g., the one for which the number of tests has already been reduced). In order to achieve this, the minimum number of tests, the test (e.g., effort) reduction may be set to R-max (e.g., ⅔). In addition to this, at least n_min tests are to be performed in a particular time interval. Hence, as another boundary condition, the number of tests n_min may be set.

Acts 1. and 2. as just described may be repeated after each time interval. It is possible to repeat acts 1. and 2. periodically not after each time interval but after a number of time intervals have passed in order to reduce the test efforts. Hence, after having determined the possible test reduction and/or the corresponding inspection second rate, this second inspection rate may be applied to the testing station. In other words, the second inspection rate is used for testing the products.

### 3. Monitoring

To monitor test reduction, multiple metrics may be calculated and/or displayed or otherwise be brought to the attention of a user (e.g., an alarm may be raised) during or after a time interval. The most important parameter for monitoring is the derived probability of error. This probability of error may be recalculated (e.g., several times) within the time interval (e.g., in sub-intervals) in order to check whether the predicted test reduction still is valid. If the error probabilities significantly deviate from the one predicted for the time interval, a new test reduction is calculated (e.g., another inspection rate is determined). In addition, one or more of the following metrics may be determined: Number of real errors; number of outliers defined by the inter quartile range of the distribution from the previous time interval; similarity of the distributions of the current and previous time interval using the Kolmogorov-Smirnov and/or Anderson-Darling tests; further moments of the distributions in the current time interval (e.g., mean, standard deviation, and/or Kurtosis, etc.); and process capability index values. If there are too many deviations between the previous and the present time intervals, an alarm may be raised, and the test reduction (e.g., the inspection rate) may be accordingly adjusted.

Hence, appropriate data to estimate the failure rate/probability p of a product (e.g., a panel) is to be provided. Further, a time interval or a number of products based on which the test reduction is performed is to be provided. A certainty for having not more than the number of slips k allowed in that time interval is to be provided (e.g., a 99% certainty not to have more than 1 slip). Then, the number of tests that may be skipped in the next time interval (e.g., under the assumption that the failure probability for the production of the product is stable) may be determined. The failure probability P may be monitored during the time intervals in order to intervene and take preventive measures in case necessary. The probability for having not more than a predetermined number of slips k differs between different product groups or types and/or different time intervals.

For the estimation of the failure probability, the following acts may be executed (e.g., iteratively):

1. Collect test results (e.g., measurements) of a previous time interval (e.g., including x days (x is a parameter that may be setsuch as set to 90)). These test results may then form a data set.

2. Sample n times K data points (e.g., corresponding to the measurements) out of the data set (e.g., using exponential or uniform weighting) to generate bootstrap samples. This is done in order to improve the estimate of the probability (e.g., distribution) P to be determined.

3. If measurements of the test variables 5 are continuous (e.g., voltage, electrical current, etc.), a kernel density estimation (KDE) may be used in order to fit the distribution and compute the area outside of specified limits. Then, the estimates may be aggregated in order to determine a stable and good estimator of the failure probability P. Alternatively, a Bayesian estimator may be computed for the failure probability by regarding the data as the outcome of a Bernoulli experiment. Hence, it is possible to compute the posterior distribution by using Bayes Theorem. Both methods lead to a distribution over P (e.g., either via bootstrap or via Bayes Theorem). A certain percentile (e.g., 90%) will be used as an estimator for the failure probability p. If a KDE and Bayes estimator is present, the larger one will be used in the next act.

4. Use the binomial distribution together with predefined certainties α and a maximum number of slips k to solve for n (e.g., the number of skipped tests for the next time interval (resulting in a reduced, second inspection rate)).

5. These acts may be repeated after a lapsed time interval (e.g., on a daily, weekly, monthly basis).

The computed test reduction per iteration may be valid for a defined time frame (e.g., for one month). However, in order to provide that the computed test reduction is valid, the failure probability may be monitored on a shorter time interval basis (e.g., on a daily basis). If the probability estimator increases drastically, the production process may be halted or the inspection rate adapted again. For example, in such a case, testing may be increased again (e.g., all of the products may be subject to inspection and testing).

Now, the estimation of the probability distribution of (not) fulfilling the inspection including one or more testing steps is described in more detail. Two different approaches to estimate the probability of error may be used: KDE and Bayes. Throughout the present disclosure, probability of error and failure probability is used interchangeably.

If the test variables are continuous, the drawn bootstrap samples may be fitted using KDE. Together with the given pre-determined limits, per test variables (e.g., one or more thresholds that define whether a product passes or fails inspection), a bootstrap distribution may be derived. Then, the median or other percentiles of the bootstrap distribution may be chosen as the probability for failing (or passing) one or more test of an inspection.

For the Bayesian estimator, the data is treated as the outcome of a Bernoulli experiment (e.g., like a simple coin-toss). The data may be weighted (e.g., either uniformly or exponentially). Afterwards, the probability distribution may be calculated based on the following formula:

$$p \left(\left(π\right| {D}^{′}\right) = \frac{p \left(\left({D}^{′}\right| π\right) p \left(π\right)}{p \left({D}^{′}\right)}$$

where π is the failure probability, p(D′|π) is a likelihood function for the Bernoulli experiment (e.g., the posterior probability distribution), p(D′) is a normalization constant, and p(π) is a prior belief of the probability distribution (e.g., a prior probability distribution to the posterior probability distribution). A conjugate prior (e.g., the Beta distribution) is used. The parameters a and b of the Beta distribution may (e.g., initially) be manually set (e.g., a=1 and b=1 to yield a uniform distribution) or may be derived from the posterior distribution (e.g., by continuously updating the parameters of the Beta distribution). A combination of the KDE estimate and the Bayes estimate may be used. If the data is discrete, the Bayesian estimate may be used. If the data is continuous, KDE estimates for the prior belief of the probability distribution may be used. Alternatively, the maximum value of the probability of error (e.g., based on KDE or Bayes approach) may be used. In that case, both the KDE and Bayes approach may be performed.

Alternatively, a Bayesian estimator for the probability p of error allows for continuous adapting and hence improving the probability of error estimate. Further, an innovation factor µ, running between 0 and 1, may be used to weight the previous posterior as part of the new prior: Pₚᵣᵢₒᵣ(n+1) = (1- µ) Pₚₒₛₜₑᵣᵢₒᵣ(n) + µ Pₚᵣᵢₒᵣ(n), where the prior Pₚᵣᵢₒᵣ is actually time independent, and n designates consecutive time interval of production.

Now, after having obtained (e.g., computed), as described in the above, the p estimator π, the test reduction n may be determined based on the following formula:

$$P \left(n , π , k \leq {k}^{′}\right) = {\sum }_{k = 0}^{{k}^{′}} \left(\frac{n}{k}\right) {π}^{k} {\left(1 - π\right)}^{\left(n - k\right)} \geq α$$

Here, k′ and α may be pre-defined (e.g. by a user). Alternatively, k′ and α may be set when creating the computer code that is executed when performing the method acts as described in the above. For example, α = 0.99 and k′ = 1 provides that n tests may be skipped while being 99% confident of not having more than k′ slips (e.g., malfunctioning products which have skipped the testing). The formula given in the above may be solved numerically for n. Based on the number of test n that may be skipped, the inspection rate of products may be changed (e.g., from a first inspection rate (for a first time interval) to a second inspection rate (for a subsequent time interval)). There, inspection rate defines the number of products 2 that are testes relative to the total number of products 2 produced.

The embodiments provide low entry barriers since most customers already have a database for test results. Compared to other closed-loop analytics methods, no other data connection than the one to a database with such test results is necessary. Further advantages inlcude that no dedicated sensors are necessary and that the model is comprehensible to a human since no black box, as in the case of artificial neural networks, is involved. This causes greater confidence in the methods used. Further, a continuous monitoring and adaptation of test reduction is enabled. The duration of the learning phase may be significantly reduced (e.g., by using a bootstrapping algorithm as proposed). Overall, higher-quality prediction models for quality forecasting with possibly very short learning time are provided herewith.

The application possibilities of predictive models, which Siemens already offers today, are expanded. The predictive models used become more reliable, and it may be possible to standardize predictive models for certain processes. The scaling and/or transferability of the models used is significantly simplified, as no longer, machine learning algorithms such as artificial neural networks are to be trained.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of operating a production for producing a plurality of products, the method comprising:
inspecting the plurality of products according to a first inspection rate, the first inspection rate determining a number of products of the plurality of products that are inspected during a period of time, from a given set of products, or during the period of time and from the given set of products, wherein inspecting one product of the plurality of products comprises testing at at least one inspection station;
obtaining test data based on the inspecting of at least one product of the plurality of products;
determining, based on the obtained test data, a probability distribution of one or more test variables measured when testing the plurality of products;
setting a threshold for a number of products of the plurality of products not fulfilling the testing;
determining a second inspection rate based on the set threshold and the probability distribution; and
inspecting the plurality of products according to a second inspection rate.

2. (canceled)

3. The method of claim 1, wherein determining the probability distribution of the one or more test variables comprises fitting the test data based on a kernel density estimation.

4. The method of claim 1, wherein determining the probability distribution of the one or more test variables comprises determining historical values of the one or more test variables, and
wherein the historical values comprise values of test variables during a preceding time interval for testing.

5. The method of claim 1, wherein determining the probability distribution of the one or more test variables comprises sampling historical values of the one or more test variables according to a statistical bootstrap model.

6. The method of claim 1, wherein the sampling according to the bootstrap model comprises the weighting the historical values based on chronological order of the historical values.

7. The method of claim 1, wherein determining the second inspection rate comprises:
setting a probability for the threshold of the number of products of the plurality of products not fulfilling the testing; and
determining the second inspection rate based on the set probability and the threshold of the number of products not fulfilling the testing and the determined probability distribution determined.

8. The method of claim 1, further comprising limiting a number of values of test variables measured during a time interval to a minimum number.

9. The method of claim 1, repeating the inspecting of the plurality of products according to the first inspection rate, the obtaining, the determining of the probability distribution, the setting, the determining of the second inspection rate, the inspecting of the plurality of products according to the second inspection rate regularly.

10. The method of claim 1, further comprising during a time interval, repeatedly determining the probability distribution and comparing the determined probability distributions.

11. The method of claim 1, further comprising:
adjusting the first inspection rate based on the number of products not fulfilling the testing;
adjusting the first inspection rate based on a number of deviations from an interquartile range of a previous time interval;
adjusting the first inspection rate based on a similarity metric of two intervals;
adjusting the first inspection rate based on one or more moments of the probability distribution;
adjusting the first inspection rate based on process capability index; or
any combination thereof.

12. An apparatus for operating a production for producing a plurality of products, the apparatus comprising:
a processor configured to:
inspect the plurality of products according to a first inspection rate, the first inspection rate determining a number of products of the plurality of products that are inspected during a period of time, from a given set of products, or during the period of time and from the given set of products, wherein the inspection of one product of the plurality of products comprises testing at at least one inspection station;
obtain test data based on the inspection of at least one product of the plurality of products;
determine, based on the obtained test data, a probability distribution of one or more test variables measured when testing the plurality of products;
set a threshold for a number of products of the plurality of products not fulfilling the testing;
determine a second inspection rate based on the set threshold and the probability distribution; and
inspect the plurality of products according to a second inspection rate.

13. (canceled)

14. A production system comprising:
one or more apparatuses for operating a production for producing a plurality of products, an apparatus of the one or more apparatuses comprising:
a processor configured to:
inspect the plurality of products according to a first inspection rate, the first inspection rate determining a number of products of the plurality of products that are inspected during a period of time, from a given set of products, or during the period of time and from the given set of products, wherein the inspection of one product of the plurality of products comprises testing at at least one inspection station;
obtain test data based on the inspection of at least one product of the plurality of products;
determine, based on the obtained test data, a probability distribution of one or more test variables measured when testing the plurality of products;
set a threshold for a number of products of the plurality of products not fulfilling the testing;
determine a second inspection rate based on the set threshold and the probability distribution; and
inspect the plurality of products according to a second inspection rate.

15. In a non-transitory computer-readable storage medium that stores instructions executable by one or more processors to operate a production for producing a plurality of products, the instructions comprising:
inspecting the plurality of products according to a first inspection rate, the first inspection rate determining a number of products of the plurality of products that are inspected during a period of time, from a given set of products, or during the period of time and from the given set of products, wherein inspecting one product of the plurality of products comprises testing at at least one inspection station;
obtaining test data based on the inspection of at least one product of the plurality of products;
determining, based on the obtained test data, a probability distribution of one or more test variables measured when testing the plurality of products;
setting a threshold for a number of products of the plurality of products not fulfilling the testing;
determining a second inspection rate based on the set threshold and the probability distribution; and
inspecting the plurality of products according to a second inspection rate.

16. The non-transitory computer-readable storage medium of claim 15, wherein determining the probability distribution of the one or more test variables comprises fitting the test data based on a kernel density estimation.

17. The non-transitory computer-readable storage medium of claim 15, wherein determining the probability distribution of the one or more test variables comprises determining historical values of the one or more test variables, and
wherein the historical values comprise values of test variables during a preceding time interval for testing.

18. The non-transitory computer-readable storage medium of claim 15, wherein determining the probability distribution of the one or more test variables comprises sampling historical values of the one or more test variables according to a statistical bootstrap model.

19. The non-transitory computer-readable storage medium of claim 15, wherein the sampling according to the bootstrap model comprises weighting the historical values based on chronological order of the historical values.

20. The non-transitory computer-readable storage medium of claim 15, wherein determining the second inspection rate comprises:
setting a probability for the threshold of the number of products of the plurality of products not fulfilling the testing; and
determining the second inspection rate based on the set probability and the threshold of the number of products not fulfilling the testing and the determined probability distribution.
